(19) United States
(12) Patent Application Publication
(10) Pub. No.: US 2026/0069108 A1
(43) Pub. Date: Mar. 12, 2026

(54) ELECTROMAGNETIC LOCKING STRUCTURE FOR DISHWASHER HOOD

(71) Applicant: Ecolab USA Inc., Saint Paul, MN (US)

(72) Inventors: Tian Qian, Shanghai (CN); Wensheng Yu, Shanghai (CN); Shuchen Zhou, Shanghai (CN)

(21) Appl. No.: 19/133,169

(22) PCT Filed: Feb. 28, 2023
(86) PCT No.: PCT/CN2023/078584

§ 371 Date: May 27, 2025

(51) Int. Cl. A47L 15/42; A47L 15/00; E05B 47/00

(52) U.S. Cl. CPC A47L 15/4259; A47L 15/0081; A47L 15/4274; E05B 47/0002

(57) ABSTRACT

A dishwasher (100) may include a wash chamber and a hood (310). The wash chamber holds items to be washed. A wash cycle may include a period of time at a predetermined temperature such that items that complete the wash cycle are sterilized. If the hood is opened during a wash cycle, water may escape from the wash chamber and air may enter the wash chamber, interrupting the sterilization of items. An electromagnetic locking structure (500) or a pin (550) locking structure is used to keep the hood closed during the wash cycle. The locking structure prevents the hood from being opened unless an amount of force applied exceeds a predetermined threshold. If the applied force exceeds the predetermined threshold, the hood is opened without being damaged. The electromagnetic locking structure may comprise an electromagnet attached to a body of the dishwasher and an iron ingot (510) attached to the hood.

### BACKGROUND

A dishwasher may clean items (e.g., dishes, utensils, or the like). The dishwasher may include a wash chamber, and the items may be located in the wash chamber. While the wash chamber is closed, the temperature and humidity of the wash chamber may be controlled by the dishwasher, allowing for sterilization of the items being cleaned. Opening the dishwasher hood while the items are being washed may interrupt the wash cycle, resulting in the entire wash cycle being repeated or improperly cleaned items being used.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1A, 1B, 1C, and 1D are illustrations of an embodiment of a dishwasher, with FIG. 1A showing a front view, FIG. 1B showing a side view with a hood of the dishwasher closed, FIG. 1C showing a side view with the hood open, and FIG. 1D showing a top view

FIG. 2 is an illustration of an embodiment of the dishwasher of FIG. 1 with examples of accessories.

FIG. 3 illustrates an isometric view of a dishwasher comprising a hood, according to some example embodiments.

FIG. 4 illustrates isometric views of the dishwasher of FIG. 3, with the hood opened and closed, according to some example embodiments.

FIG. 5 illustrates an electromagnetic locking structure for a dishwasher hood, according to some example embodiments.

FIG. 6 illustrates a pin locking structure for a dishwasher hood, according to some example embodiments.

FIG. 7 illustrates a block diagram of an example machine according to one embodiment of the present subject matter.

### DETAILED DESCRIPTION

A dishwasher may include a wash chamber and a hood. The wash chamber holds items to be washed. While the hood is closed, the wash chamber is watertight. While the hood is opened, items may be added to or removed from the wash chamber. A wash cycle may include a period of time at a predetermined temperature such that items that complete the wash cycle are sterilized.

If the hood is opened during a wash cycle, water may escape from the wash chamber, inconveniencing an operator of the dishwasher. Additionally, air may enter the wash chamber, interrupting the sterilization of items. To ensure sterilization after the wash cycle is interrupted by opening the hood, the wash cycle is restarted.

According to the systems and methods disclosed herein, an electromagnetic locking structure is used to keep the hood closed during the wash cycle. In alternative embodiments, a pin locking structure is used. The locking structure prevents the hood from being opened unless an amount of force applied exceeds a predetermined threshold. If the applied force exceeds the predetermined threshold, the hood is opened without being damaged.

The electromagnetic locking structure may comprise an electromagnet attached to a body of the dishwasher and an iron ingot attached to the hood. When an electric current is provided to the electromagnet, the electromagnet generates a magnetic field that attracts the iron ingot. The force required to disengage the iron ingot from the electromagnet and open the hood is dependent on the physical properties (e.g., size, shape, and chemical composition) of the iron ingot and the electromagnet and the amount of current provided. Thus, during manufacture, physical properties of the iron ingot at the electromagnet may be determined in order to control the opening force for a constant current value. Alternatively, after manufacture, the current provided to the electromagnet may be modified to adjust the opening force.

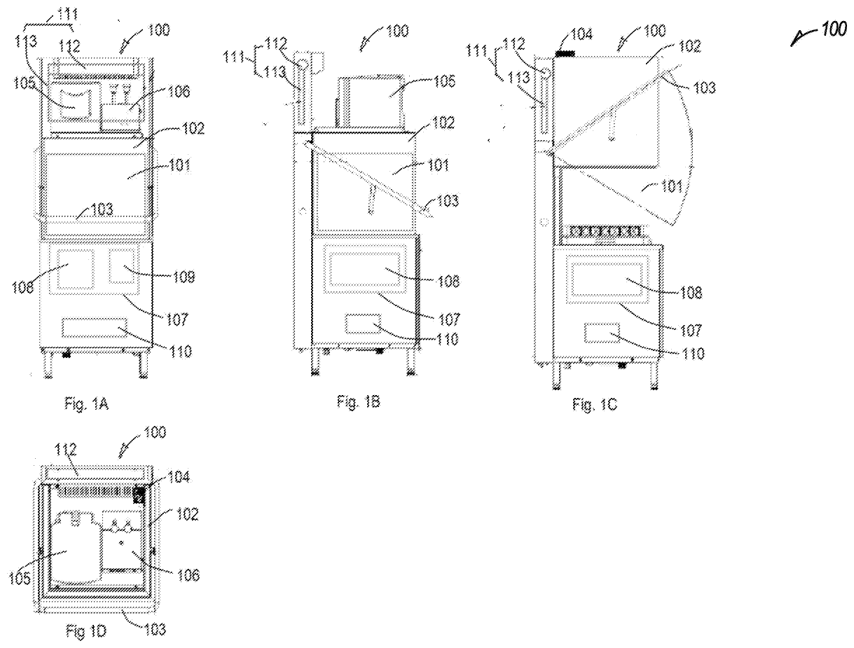

FIGS. 1A, 1B, 1C, and 1D are illustrations of an embodiment of a dishwasher 100. As shown in FIGS. 1A-1D and discussed as an example for illustrative but not restrictive purposes, dishwasher 100 is a hood-type dishwasher that includes a hood 102 to cover a wash chamber (also known as a main wash chamber) 101 during each cleaning cycle. A hood lifting handle 103 can be elevated by a user to open hood 102 for loading objects to be washed into wash chamber 101 before a cleaning cycle, lowered by the user to close hood 102 to cover the wash chamber 101 before starting the cleaning cycle, and elevated by the user to open hood 102 for unloading the cleaned objects after the cleaning cycle is completed. A hood lock 104 installed on hood 102 is automatically locked when a cleaning cycle starts to prevent hood 102 from being accidentally opened during the clean cycle. FIG. 1A shows a front view of dishwasher 100 when hood 102 is closed. FIG. 1B shows a side view of dishwasher 100 when hood 102 is closed. FIG. 1C shows a side view of dishwasher 100 when hood 102 is open. FIG. 1D shows a top view of dishwasher 100.

Dishwasher 100 includes a dispenser 105 that contains various chemical agents for dispensing during different periods of the cleaning cycle. Each chemical agent may be in liquid or solid form, and dispenser 105 is configured to accommodate liquid and/or solid forms for each chemical agent, depending on the form(s) of the chemical agent that is available and intended to use. Each chemical agent in dispenser 105 is refillable. In one example, dishwasher 100 can perform cleaning cycles including a descaling period, a washing period, and a rinsing period, and dispenser 105 is an integrated dispenser that can contain a descaler, a detergent, and a rinse aid and can dispense the descaler for use during the descaling period, the detergent for use during the washing period, and the rinse aid for use during the rinsing period.

Dishwasher 100 includes a user interface 106 that visually and/or audially indicates its operational status and allows the user to control its operations. User interface 106 can include a display screen, such as a touchscreen that can display the operation status of dishwasher 100 and receive commands and other information from the user. User interface 106 can include a power switch for the user to turn the electrical power for dishwasher 100 on and off. User interface 106 allows the user to start a cleaning cycle, optionally after indicating to the user that the cleaning cycle is ready to start (e.g., after hood 102 is closed). In one example, user interface 106 allows the user to select which period(s) to include in the cleaning cycle. The user may select only the rinsing period when, for example, dishes are known to be clean but needs disinfection. The user may select the washing and rinsing periods only when a need for descaling dishes is not indicated. In another example, user interface 106 is configured (e.g., programmed) for following a hygiene procedure and/or complying with a regulation for ensuring food safety.

Dishwasher 100 provides high space and power efficiency to lower operational cost and/or allowing a food service establishment to operate under limited space and/or electrical power capacity. For example, dishwasher 100 includes an internal wastewater recycling system 107 and an internal steam reduction system 111 to recover thermal energy resulting from the operations during each cleaning cycle for heating clean water to be used in the operations. Wastewater recycling system 107 includes a wash tank (also known as main wash tank) 108 recycling a hot washing liquid to be sprayed into, and returning from, wash chamber 101 during the washing period and a wastewater tank 109 (also known as overflow tank) to receive excessive hot washing liquid from wash tank 108 as wastewater. A heat exchange module is placed in wastewater tank 109 to heat clean water while cooling the wastewater before it is discharged to a drain (e.g., a drain connected to the sewage of the building). The heated clean water is to be added to wash tank 108 and a booster tank (also known as rinse tank) 110 as needed. In the illustrated example, booster tank 110 receives the clean water and the descaler to form a descaling liquid to be sprayed into wash chamber 101 during the descaling period and receives the clean water and the rinse aid to form a rinsing liquid to be sprayed into wash chamber 101 during the rinsing period. Steam reduction system 111 includes a fan 112 to draw steam from wash chamber 101 and a condenser 113 positioned in the steam path to condense the steam while heating the clean water (in addition to the heat recovery from the wastewater). Fan 112 blows the remaining steam out of dishwasher 100.

Dishwasher 100 can be sized to allow for easy operation and maintenance by a user having a height of 150 cm or taller. Force required to open hood 102 by elevating hood lifting handle 103 can be around 3.5 kg (about 35 Newtons) or lighter when the hood is not locked. In one example, wash tank 108 has a capacity of about 24 L, wastewater tank 108 has a capacity of about 12 L, and booster tank 110 has a capacity of about 10 L.

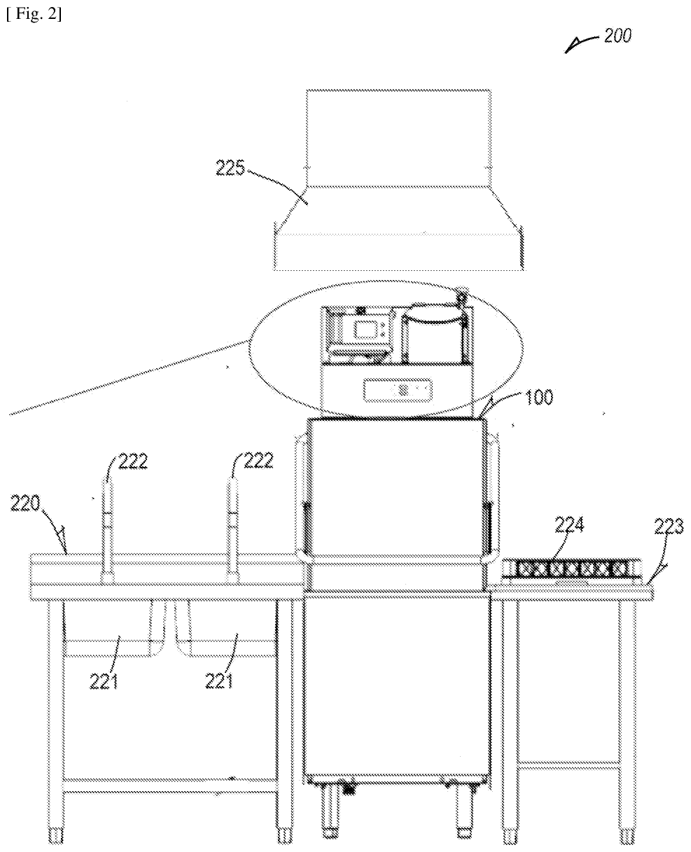

FIG. 2 is an illustration of an embodiment of dishwasher 100 with several accessories. As shown in FIG. 2 as an example for illustrative but not restrictive purposes, the accessories can include a dirty dish stand 220, a clean dish stand 223, a dishwasher rack 224, and a vent hood 225. Dirty dish stand 220 includes one or more sinks 221 and one or more faucets 222. When necessary or convenient, dishes and/or other objects to be cleaned can be placed in sink(s) 221 and pre-washed using water from faucet(s) 222 before being loaded into wash chamber 101 (with hood 102 open). Rack 224 can be placed in wash chamber 101 when empty, and the dishes and/or other objects can be placed into rack 224 for each cleaning cycle. After the cleaning cycle is completed, rack 224 loaded with the cleaned dishes and/or other objects can be removed from wash chamber 101 (with hood 102 open) and placed on clean dish stand 223 before use and/or further distribution. Vent hood 225 can vent the steam blown out of dishwasher 100 by fan 113 to outside of the building in which dishwasher 100 is placed.

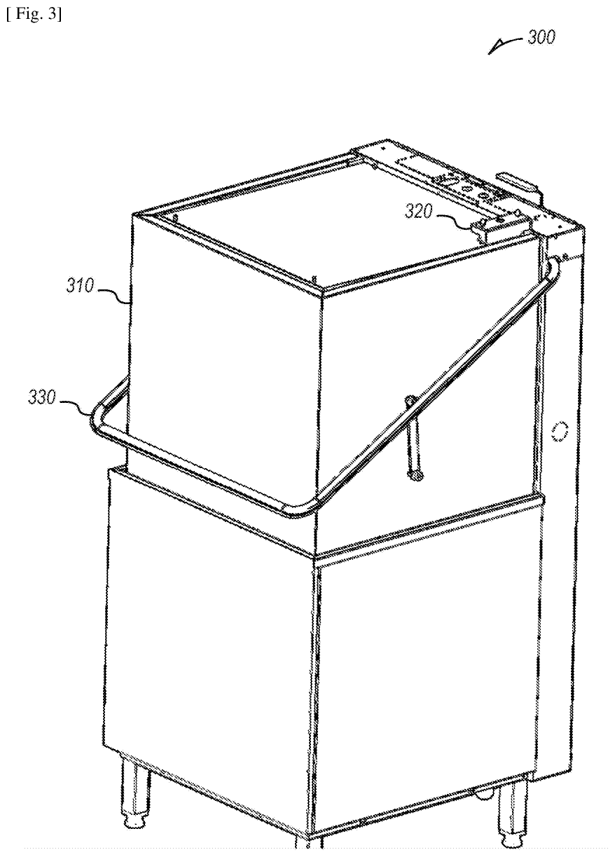

FIG. 3 illustrates an isometric view of a dishwasher 300 comprising a hood 310, according to some example embodiments. An electromagnetic lock 320, when activated, keeps the hood closed unless at least a predetermined force is applied.

For example, lever arm 330 may be lifted, causing, via a gear mechanism in the dishwasher 300, vertical force to be applied to the hood 310. If the vertical force exceeds the predetermined force (e.g., about 25 Newtons, about 250 Newtons, or another predetermined force), the attractive strength of the electromagnetic lock 320 is overcome and the hood lifts from a wash chamber of the dishwasher 300. Overcoming the strength of the magnetic lock does not damage an electromagnet of the electromagnetic lock 320, an iron ingot of the electromagnetic lock 320, the hood 310, or the wash chamber of the dishwasher 300.

The electromagnetic lock 320 is activated by providing an electric current to an electromagnet mounted to the body of the dishwasher 300. For example, power may be supplied from a 12-Volt power source to a wire wound about an iron core, causing magnetic flux to pass through the iron core. When activated, the electromagnet attracts an iron ingot mounted to the hood 310. Thus, the iron ingot magnetically couples to the electromagnet while the hood is closed and the electric current is provided to the electromagnet. By removing the current from the electromagnet, the attraction between the electromagnet and the iron ingot ceases, releasing the hood 310. The current may be automatically supplied to the electromagnet at the beginning of a wash cycle and automatically removed when the wash cycle completes. A sensor may detect that the hood 310 is closed and the wash cycle may only be begun if the hood 310 is closed. The sensor may detect that the hood 310 is opened during the wash cycle and terminate the wash cycle in response.

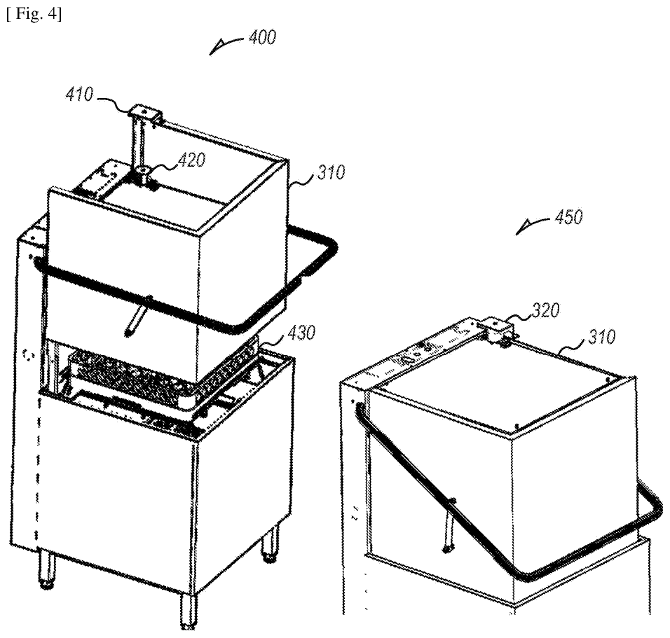

FIG. 4 illustrates isometric views 400 and 450 of the dishwasher 300 of FIG. 3, with the hood 310 opened and closed, according to some example embodiments. In the view 450, the hood 310 is closed and secured by the electromagnetic lock 320. In the view 400, the hood 310 is opened, revealing the electromagnet 420 and the wash chamber 430. Iron ingot 410 is separated from the electromagnet 420.

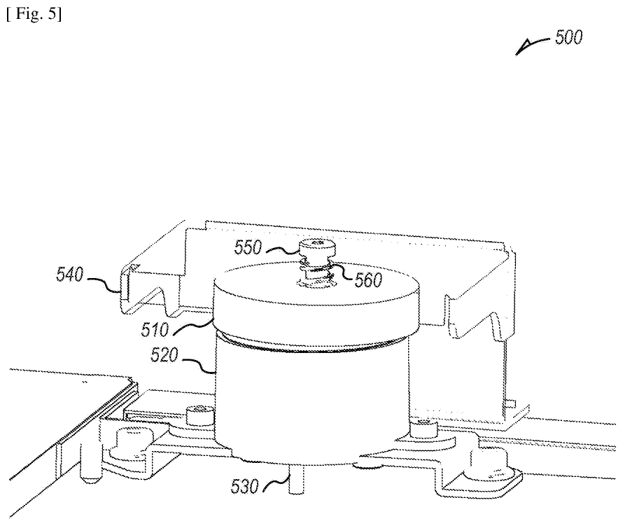

FIG. 5 illustrates an electromagnetic locking structure 500 for a dishwasher hood, according to some example embodiments. The electromagnetic locking structure 500 includes an iron ingot 510, an electromagnet 520, a cable 530, a housing 540, a pin 550, and a spring 560.

The electromagnet 520, when activated, receives an electric current via the cable 530 and generates a magnetic field. When deactivated, the cable 530 does not provide power to the electromagnet 520 and the electromagnet 520 does not generate a magnetic field. Likewise, if power to the dishwasher is lost (e.g., in a power outage, due to the power cable to the dishwasher being connected, or for another reason), power to the electromagnet 520 may be disrupted, causing the electromagnet 520 to cease generating the magnetic field. When the electromagnet 520 generates a magnetic field, the iron ingot 510 is attracted to the electromagnet 520. The iron ingot 510 is mounted to the hood (e.g., the hood 310 of FIG. 3) by the pin 550. The iron ingot 510 may have some degree of angular freedom with respect to the pin 550. Thus, in some example embodiments, the hood 310 of FIG. 3 comprises the pin 550 that couples the hood 310 to the iron ingot 510, such that the pin 550 is configured to allow the iron ingot 510 to change position in response to a magnetic field generated by the electromagnet 520.

The spring 560 allows the iron ingot some flexibility of motion. For example, the spring 560 may be a component of the hood 310 of FIG. 3 and the spring 560 may provide floating angular deflection to the iron ingot. Thus, the angle of iron ingot 510 to the pin 550 (shown as 90 degrees in FIG. 5) may change in a predetermined range of motion (e.g., 10, 15, 20, 25, or 30 degrees from perpendicular). The iron ingot 510 may be encased in the housing 540. The housing 540 may be water-tight and waterproof (e.g., made of plastic) to prevent water from contacting the iron ingot 510, which may rust when wet. Thus, the hood 310 of FIG. 3 may comprise a plastic enclosure about the iron ingot, the plastic enclosure configured to protect the iron ingot from moisture.

During production, the dishwasher may undergo a 96-hour salt spray test to verify that the components will not be damaged by salt water during normal use. Similarly, a chemical alkali vapor test may be performed to verify resistance to chemical alkali vapors.

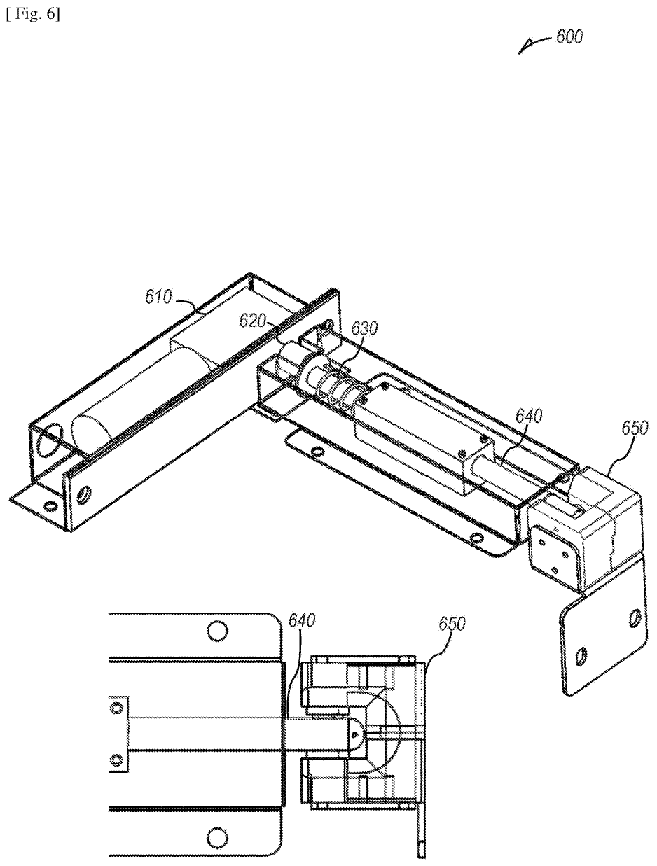

FIG. 6 illustrates a pin locking structure 600 for a dishwasher hood, according to some example embodiments. The pin locking structure 600 includes a motor 610, a locking tongue 620, a spring 630, a shaft 640, and a limit block 650. The motor 610 is engaged to extend or retract the locking tongue 620. When the locking tongue 620 is retracted, the hood 310 of FIG. 3 may be lifted without resistance. When the locking tongue 620 is extended, the shaft 640 is pushed into the limit block 650. As a result, the hood 310 may not be lifted without overcoming resistance from the shaft 640. If sufficient force is applied to the hood 310, the limit block 650 begins to move, forcing the shaft 640 to compress the spring 630 and allowing the hood 310 to be opened without damaging the hood 310 or the pin locking structure 600. The shape of the limit block 650, the shape of the shaft 640, and the spring constant of the spring 630 may be selected to control the force needed to open the hood 310 while the locking tongue 620 is extended. For example, a force of 25 Newtons or 250 Newtons may be selected to allow for a deliberate effort to open the hood 310 while informing a user that the hood 310 is deliberately closed and resisting being opened.

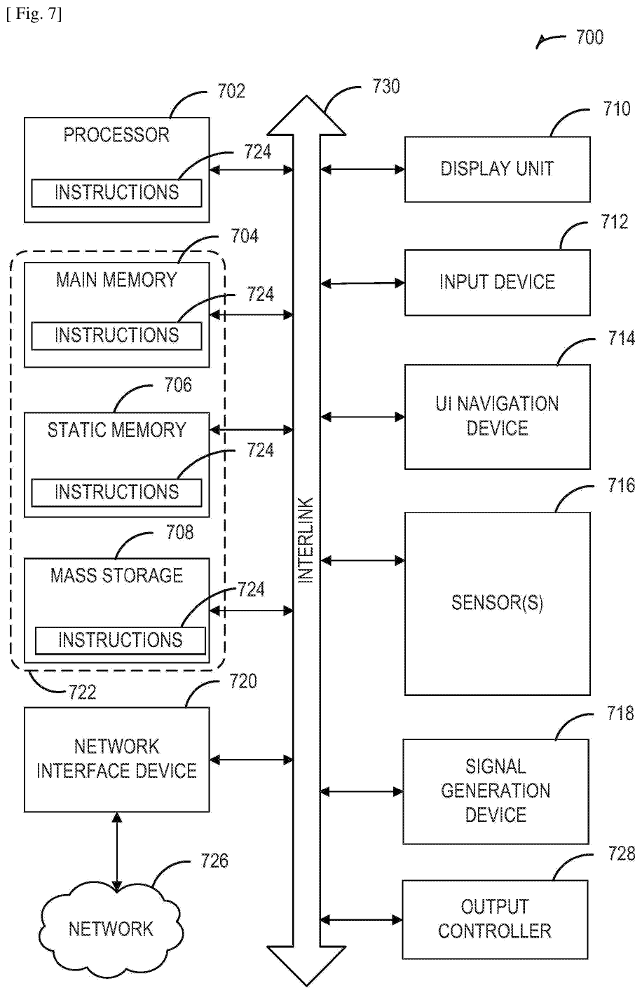

FIG. 7 illustrates a block diagram of an example machine 700 upon which any one or more of the techniques (e.g., methodologies) discussed herein may perform, according to one embodiment of the present subject matter. Examples, as described herein, may include, or may operate by, logic or a number of components, or mechanisms in the machine 700. Circuitry (e.g., processing circuitry), is a collection of circuits implemented in tangible entities of the machine 700 that include hardware (e.g., simple circuits, gates, logic, etc.) . The machine 700 may be implemented as a printed circuit board (PCB) within the dishwasher 300 of FIG. 3. Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 700 follow.

In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 700 may include a hardware processor 702 (e.g., a central processing unit (CPU), a graphics processing unit (GPU), a hardware processor core, or any combination thereof), a main memory 704, a static memory (e.g., memory or storage for firmware, microcode, a basic-input-output (BIOS), unified extensible firmware interface (UEFI), etc. ) 706, and mass storage 708 (e.g., hard drive, tape drive, flash storage, or other block devices) some or all of which may communicate with each other via an interlink (e.g., bus) 730. The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include mass storage (e.g., drive unit) 708, a signal generation device 718 (e.g., a speaker), a network interface device 720, and one or more sensors 716, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 702, the main memory 704, the static memory 706, or the mass storage 708 may be, or include, a machine readable medium 722 on which is stored one or more sets of data structures or instructions 724 (e.g., software) embodying or utilized by any one or more of the techniques or functions described herein. The instructions 724 may also reside, completely or at least partially, within any of registers of the processor 702, the main memory 704, the static memory 706, or the mass storage 708 during execution thereof by the machine 700. In an example, one or any combination of the hardware processor 702, the main memory 704, the static memory 706, or the mass storage 708 may constitute the machine-readable media 722. While the machine readable medium 722 is illustrated as a single medium, the term “machine readable medium” may include a single medium or multiple media (e.g., a centralized or distributed database, and/or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine-readable medium examples may include solid-state memories, optical media, magnetic media, and signals (e.g., radio frequency signals, other photon-based signals, sound signals, etc.). In an example, a non-transitory machine-readable medium comprises a machine-readable medium with a plurality of particles having invariant (e.g., rest) mass, and thus are compositions of matter. Accordingly, non-transitory machine-readable media are machine readable media that do not include transitory propagating signals. Specific examples of non-transitory machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may be further transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 700, and includes digital or analog communications signals or other intangible medium to facilitate communication of such software. A transmission medium is a machine-readable medium.

### EXAMPLES

Example 1 is a dishwasher comprising: a wash chamber for holding items to be washed; a hood configured to be placed in an open position and a closed position, such that while the hood is in the open position, items may pass through an opening in the wash chamber and while the hood is in the closed position, the wash chamber is water-tight; and an electromagnet that holds the hood in the closed position while electric current is provided to the electromagnet unless an amount of force that exceeds a predetermined threshold is applied to the hood.
In Example 2, the subject matter of Example 1, wherein the predetermined threshold is about 25 Newtons.
In Example 3, the subject matter of Examples 1-2, wherein the predetermined threshold is about 250 Newtons.
In Example 4, the subject matter of Examples 1-3, wherein the hood further comprises an iron ingot that magnetically couples to the electromagnet while the hood is closed and the electric current is provided to the electromagnet.
In Example 5, the subject matter of Example 4, wherein the hood further comprises a plastic enclosure about the iron ingot, the plastic enclosure configured to protect the iron ingot from moisture.
In Example 6, the subject matter of Examples 4-5, wherein the hood further comprises a pin that couples the hood to the iron ingot, the pin configured to allow the iron ingot to change position in response to a magnetic field generated by the electromagnet.
In Example 7, the subject matter of Examples 4-6, wherein the hood further comprises a spring that provides floating angular deflection to the iron ingot.
In Example 8, the subject matter of Examples 1-7, wherein the electric current is provided from a 12-volt power source
Example 9 is a lock apparatus for a dishwasher, comprising: an electromagnet and an iron ingot that are magnetically coupled while electric current is provided to the electromagnet, holding a hood in a closed position unless an amount of force that exceeds a predetermined threshold is applied to the hood.
In Example 10, the subject matter of Example 9, wherein the predetermined threshold is about 25 Newtons.
In Example 11, the subject matter of Examples 9-10, wherein the predetermined threshold is about 250 Newtons.
In Example 12, the subject matter of Examples 9-11, wherein the iron ingot is enclosed in a plastic enclosure configured to protect the iron ingot from moisture.
In Example 13, the subject matter of Examples 9-12, wherein the iron ingot is coupled to the hood by a pin configured to allow the iron ingot to change position in response to a magnetic field generated by the electromagnet.
In Example 14, the subject matter of Examples 9-13, wherein the iron ingot is coupled to the hood by a spring that provides floating angular deflection to the iron ingot.
In Example 15, the subject matter of Examples 9-14, wherein the electric current is provided from a 12-volt power source.
Example 16 is at least one machine-readable medium including instructions that, when executed by processing circuitry, cause the processing circuitry to perform operations to implement any of Examples 1-15.
Example 17 is an apparatus comprising means to implement any of Examples 1-15.
Example 18 is a system to implement any of Examples 1-15.
Example 19 is a method to implement any of Examples 1-15.

This detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the inventors also contemplate examples in which only those elements shown or described are provided.

In this document, the terms “a” or “an” are used, as is common in patent documents, to include one or more than one, independent of any other instances or usages of “at least one” or “one or more.” In the following claims, the terms “first,” “second,” and “third,” etc. are used merely as labels, and are not intended to impose numerical requirements on their objects.

The above description is intended to be illustrative, and not restrictive. For example, the above-described examples (or one or more Examples thereof) may be used in combination with each other. Other embodiments may be used, such as by one of ordinary skill in the art upon reviewing the above description.

1. A dishwasher comprising:
a wash chamber for holding items to be washed;
a hood configured to be placed in an open position and a closed position, such that while the hood is in the open position, items may pass through an opening in the wash chamber and while the hood is in the closed position, the wash chamber is water-tight; and
an electromagnet that holds the hood in the closed position while electric current is provided to the electromagnet unless an amount of force that exceeds a predetermined threshold is vertically applied to the hood;
wherein the hood further comprises iron that magnetically couples to the electromagnet while the hood is closed and the electric current is provided to the electromagnet.

2. The dishwasher of claim 1, wherein the predetermined threshold is about 25 Newtons.

3. The dishwasher of claim 1, wherein the predetermined threshold is about 250 Newtons.

4. The dishwasher of claim 1, wherein the iron comprises an iron ingot.

5. The dishwasher of claim 4, wherein the hood further comprises a plastic enclosure about the iron ingot, the plastic enclosure configured to protect the iron ingot from moisture.

6. The dishwasher of claim 4, wherein the hood further comprises a pin that couples the hood to the iron ingot, the pin configured to allow the iron ingot to change position in response to a magnetic field generated by the electromagnet.

7. The dishwasher of claim 4, wherein the hood further comprises a spring that provides floating angular deflection to the iron ingot.

8. The dishwasher of claim 1, wherein the electric current is provided from a 12-volt power source.

9. A lock apparatus for a dishwasher, comprising:
an electromagnet and an iron ingot that are magnetically coupled while electric current is provided to the electromagnet, holding a hood in a closed position unless an amount of force that exceeds a predetermined threshold is vertically applied to the hood.

10. The lock apparatus of claim 9, wherein the predetermined threshold is about 25 Newtons.

11. The lock apparatus of claim 9, wherein the predetermined threshold is about 250 Newtons.

12. The lock apparatus of claim 9, wherein the iron ingot is enclosed in a plastic enclosure configured to protect the iron ingot from moisture.

13. The lock apparatus of claim 9, wherein the iron ingot is coupled to the hood by a pin configured to allow the iron ingot to change position in response to a magnetic field generated by the electromagnet.

14. The lock apparatus of claim 9, wherein the iron ingot is coupled to the hood by a spring that provides floating angular deflection to the iron ingot.

15. The lock apparatus of claim 9, wherein the electric current is provided from a 12-volt power source.

16. The dishwasher of claim 2, wherein the electric current is provided from a 12-volt power source.

17. The dishwasher of claim 3, wherein the electric current is provided from a 12-volt power source.

18. The lock apparatus of claim 10, wherein the electric current is provided from a 12-volt power source.

19. The lock apparatus of claim 11, wherein the electric current is provided from a 12-volt power source.

20. The lock apparatus of claim 12, wherein the electric current is provided from a 12-volt power source.
